(19) United States
(12) Patent Application Publication
(10) Pub. No.: US 2015/0089368 A1
(43) Pub. Date: Mar. 26, 2015

(54) SEARCHING WITHIN AUDIO CONTENT

(71) Applicant: Audible, Inc., Newark, NJ (US)

(72) Inventors: Kevin Scott Lester, Hoboken, NJ (US); Guy Ashley Story, JR., New York, NY (US)

(73) Assignee: Audible, Inc., Newark, NJ (US)

(21) Appl. No.: 14/037,240

(22) Filed: Sep. 25, 2013

(51) Int. Cl. G06F 3/16

(52) U.S. Cl. CPC G06F 3/162
USPC 715/716

(57) ABSTRACT

Features are disclosed for searching within audio content. Users may submit search terms in text format. An index of text that is audibly presented in the audio content may be searched to identify an instance of a search term. A play position corresponding to the instance may be obtained, and a user may be provided with access to a portion of the audio content based on the play position. The particular play position that is chosen may be based on additional factors, such as popularity of the portion, prior search history and interactions, etc.

### BACKGROUND

Computing devices, including personal and mobile devices, may be used to read books and other textual content, listen to audio books and other audio content, and watch movies and other video content. In some cases, a single content item may be available in multiple electronic formats. For example, a book may be available as both an electronic book (“e-book”) and an audio book.

Users may load content onto their devices for consumption when the devices are not connected to a network, or access network-based content for streaming consumption while connected to a network. Depending upon the format, content may be consumed using text display applications, audio playback applications, text-to-speech applications, and the like. Textual content such as an e-book, newspaper or magazine may have a table of contents, an index, a search feature, or some combination thereof to allow users to conveniently locate particular portions of the content. Audio content such as an audio book, lecture or on-demand broadcast (e.g., “podcast”) may include a track listing to facilitate locating particular portions of the content.

Users may browse and shop for electronic content in a variety of ways, such as via network sites accessible using standard browser applications, application-based marketplaces that provide content to users of particular content presentation applications, etc. In a typical implementation, a user can browse content by category, submit search queries as described above, and view ranked lists of search results. Users may also access prepackaged samples of content, such as the first 20 pages of an e-book or the first 20 minutes of an audio book.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative network environment including a content delivery system and several user devices for consuming and searching audio content.

FIG. 2 is a flow diagram of an illustrative process for searching audio content and providing search results.

FIG. 3 shows an illustrative user interface for searching a catalog of audio content and interacting with search results.

FIG. 4 shows an illustrative user interface for searching within audio content hosted by a network accessible service.

FIG. 5 shows illustrative user interfaces for searching within audio content using a mobile device.

FIG. 6 is a flow diagram of an illustrative process for selecting or updating an audio content sample based on prior searches and interactions with search results.

### DETAILED DESCRIPTION

### Introduction

Generally described, the present disclosure relates to searching within audio content. Conventionally, a user may manually search within audio content by reviewing listings and summaries of the tracks or files of an audio content item. Such listings and summaries are typically provided by a publisher or content provider. The user may then access a particular track or file that may be relevant to the user's search. However, such searching does not provide users with the option to quickly locate particular portions within a given track or file, or to locate potions of audio content based on a search of the words spoken in the audio content. Rather, a user must typically read the track listings, summaries, etc. to determine which track may include content relevant to the user's search criteria. Even if a user is searching for a keyword or topic that happens to be included in a track listing or summary, the user may be unable to begin playback of the audio content at the desired location.

Similar limitations apply to searching across a catalog of audio content items. Users searching for content in a catalog of textual content items may submit search terms (words or phrases). A search engine returns a list of items with authors, titles, and descriptions that are relevant to the search terms, and also items that include the search terms in the content itself. Some search engines provide portions of the content (e.g., passages of text) that include the search terms so that users may see the search terms in context. However, users searching for audio content in a catalog of audio content items typically receive only those search results with authors, titles and descriptions that are relevant to the search terms. Search results with portions of content that include the user-selected search terms in the content itself (e.g., words or phrases spoken within the audio content item) may not be available.

Aspects of the present disclosure relate to searching within audio content items based on words or phrases spoken in the audio content items instead of, or in addition to, the descriptions of the audio content items. In contrast to conventional searching of descriptions provided by a publisher or other content provider, the systems and methods described herein can be used to search the audio content itself, and to provide search results with content relevant to user-provided search terms. For example, a user can enter a search term and view content items, such as audio books, that would normally be returned by matching the search term to a word in the title, author, summary, etc. In addition, the search results can also include audio books whose content contains the search term (e.g., the search term was spoken in the audio book). The search results that are matched based on the content of the audio book may be presented with a passage of the audio book transcription showing the search term in context, such as the sentence before the search term, the sentence with the search term, and/or the sentence after the search term.

Search results may also include an option to listen to the portion of audio content that includes the search term (e.g., the portion that corresponds to the passage of text with the search term in context, if such a passage is displayed). Users may therefore listen to samples of audio content that are relevant to the search terms of interest to the particular user, rather than samples preselected by the publisher or content provider. For example, a user may submit a particular search term to a content delivery system or some other content provider, and the user may be presented with search results that include content items in which the search term was spoken in the content item itself. The user may access a sample of one of the audio content items to determine whether or not to purchase the particular item. If a general introduction has been preselected as the sample for the particular item, the introduction may not be of interest to a user searching for a specific topic. However, if the user is presented with portion of the audio content that includes the user's specific search term, the user may be more likely to purchase the content item or otherwise be more interested in the content item.

Additional aspects of the present disclosure relate to tracking search history and interactions with search results, and selecting or updating audio samples based on the user interactions with the search results. For example, some audio content providers allow users to sample the audio content by presenting preselected portions, such as the first 20 minutes of the content item. Such samples may be provided to all users, regardless of whether they have submitted specific search terms or if they are merely browsing content (e.g., in a list of recommendations or popular items). In some cases, the default sample (e.g., the preselected portion corresponding to the first 20 minutes) may not be particularly interesting or representative of the audio content item as a whole. Presenting a sample that is more interesting or representative of the audio content item may provide a better experience for a user, and may also increase the user's interest in the book and potentially produce additional audio content sales. In order to determine which portion to use as a content sample, data regarding prior search history and search results interactions of multiple users may be analyzed. In a system which allows users to hear their search terms in the context in which the search terms occur in the individual search results (as described above and in greater detail below), the system may track how many sales occur after users listen to various audio portions that include particular search terms in context. Portions of content that are associated with the highest number or rate of sales may be used as a general sample for the content item.

Data regarding prior searches and interactions with search results may also be used to select samples to be presented in response to specific user searches. For example, a system may present a user with several samples that include a particular search term. If users tend to listen to a particular sample more than other samples, or if users who listen to a particular sample tend to purchase the item more often than those users who listen to other samples, then the best-performing sample may be used as the top sample for the particular search terms.

Although aspects of the embodiments described in the disclosure will focus, for the purpose of illustration, on searching the content of audio books and presenting samples of audio books, one skilled in the art will appreciate that the techniques disclosed herein may be applied to any number of processes or applications. For example, the techniques disclosed herein may be applied to other types of audio or audiovisual content, such as on-demand broadcasts (e.g., podcasts), radio programs, televisions shows, movies, music and the like. Various aspects of the disclosure will now be described with regard to certain examples and embodiments, which are intended to illustrate but not limit the disclosure.

With reference to an illustrative example, a content delivery system or some other content provider may obtain or generate a transcript or index of words spoken in a particular audio content item, such as an audio book. The transcript or index may include corresponding play positions within the audio book for each word or phrase, such as a measurement of elapsed time from the beginning of the audio book or from some predetermined point at which each word or phrase is spoken in the audio book. In some embodiments, if the audio book has a corresponding text-based electronic book, also referred to as an e-book, the e-book may serve as a transcript for the audio book. The e-book and audio book may be processed to determine the play positions in the audio book of each word or phrase in the e-book (e.g., using an automatic speech recognition system). Some example systems and methods for synchronizing different formats of content (e.g., text and audio versions of the same book) are described in U.S. patent application Ser. No. 13/070,313, filed on Mar. 23, 2011 and incorporated by reference herein in its entirety.

Generally described, a play position, playback position, or presentation position may refer to any information that reflects a temporal location or position within an audio or audiovisual content item, or to any measurement of an amount of content or time between a predetermined temporal location (e.g., the beginning of the content item or track, a bookmark, etc.) and a temporal location of interest. For example, a play position of an audio book may be indicated by a timestamp or counter. In some embodiments, a play position may be reflected as a percentage (e.g., a point at which 25% of the content item remains). In other embodiments, a play position may be reflected as an absolute value (e.g., at 2 hours, 30 minutes and 5 seconds into an audio book). In some embodiments, data regarding the play position of the content may reflect the play position of a specific word, phrase, subword unit (e.g., phoneme), or the like. One skilled in the art will appreciate that a play position may be reflected by any combination of the above information, or any additional information reflective of a position within an audio content item.

In addition to generating or obtaining data associating each word or phrase of the audio book with a particular play position, the content delivery system may generate or obtain a ranked and/or weighted search index for the audio book. For example, many text-based search engines do not simply perform “brute force” word-by-word searching of text. Instead, instances of words or phrases are ranked and/or weighted based on their overall relevance. A search engine using such an index can then select the most relevant instance of the search term, or the most relevant portion of a content item that includes or otherwise corresponds to a particular search term, rather than simply returning every instance of the search term (or the first n instances, etc.). Accordingly, if the search index includes play positions for the entries of the search index, or information that may be used to obtain the play positions, the search index may be used to search for search terms in an audio content item.

A ranked and/or weighted search index may also be maintained for a catalog of audio books or other audio content items instead of, or in addition to, indices for individual content items. Individual content items that include a particular word or phrase may be included in the index for the catalog. A play position (or data that may be used to obtain the play position) of the most relevant portion or portions that include the word or phrase in context may be included in the index for each content item. The content items (or portions of content items) may be ranked by overall relevance with respect to particular words and/or phrases, such that the content item that is most relevant to a search for a particular word or phrase may be ranked first or weighted most, the content item that is the second most relevant may be ranked second or weighted second most, etc.

Users may submit search terms to a search engine that has access to the play positions for each word in the content item. The search engine may identify the most relevant result (or top n results) in the content item, and return information about the relevant results to the user. The information may include a passage of text that includes the search term (e.g., obtained from the transcript or included in the search index). In some embodiments, the search results may provide an audio sample that includes the search term in context. Moreover, audio samples of the most relevant search results may be combined into a single audio sample, such that the user may hear several results consecutively without activating a sample for each of the several results separately. In yet other embodiments, video samples or other relevant content samples may be provided with the search results when, e.g., the content being searched includes audiovisual content (e.g., movies, television shows, etc.).

In some embodiments, users may submit search terms textually, such as by typing them into a text box of a graphical user interface. In addition, users may submit search terms verbally with the aid of speech recognition. For example, a user may speak the search terms, and a transcription of the search terms (or n-best list of transcriptions) can be generated by an automatic speech recognition (“ASR”) system and provided to the search engine. In the case of n-best transcriptions, the search engine may search separately for multiple (e.g., two or more) transcriptions, and provide a single set of search results. In some embodiments, the search results may be filtered or ranked using a score (e.g., a confidence score) indicating the likelihood that each of the n-best transcriptions is correct.

A phonemic representation of search terms may also be used. In this case, the search index may include phonemic representations of each word or phrase in the audio content item (or some subset thereof) instead of, or in addition to, a textual (e.g., properly spelled) representation of the words or phrases. Users may input search terms textually, such as by typing the search terms into a text box. The textual search terms can then be converted to a phonemic representation for searching. In some embodiments, users may input search terms verbally, and the user's utterance can be recognized as a sequence of phonemes rather than a properly spelled transcription of the utterance. The phonemes may then be used to search the search index/indices.

The search engine may execute at a network-accessible content delivery system, or it may execute locally on a user computing device. In some embodiments, users may access and interact with local copies of audio content items, and initiate searches with individual content items or across their personal catalog of content items. A search engine executing locally on the user device may access a search index associated with the content item (or catalog of content items), obtain one or more relevant results, and present the results to the user. In some embodiments, a uses accessing and interacting with content on his or her local device may initiate a search within a content item, but the search query may be transmitted to a network-accessible system that executes the search. For example, a content delivery system may maintain information regarding which content items a user has purchased or to which the user otherwise has access. The content delivery system can execute searches and transmit data to the user device regarding a play position of a particular content item at which a search term may be found.

### Networked Content Consumption Environment

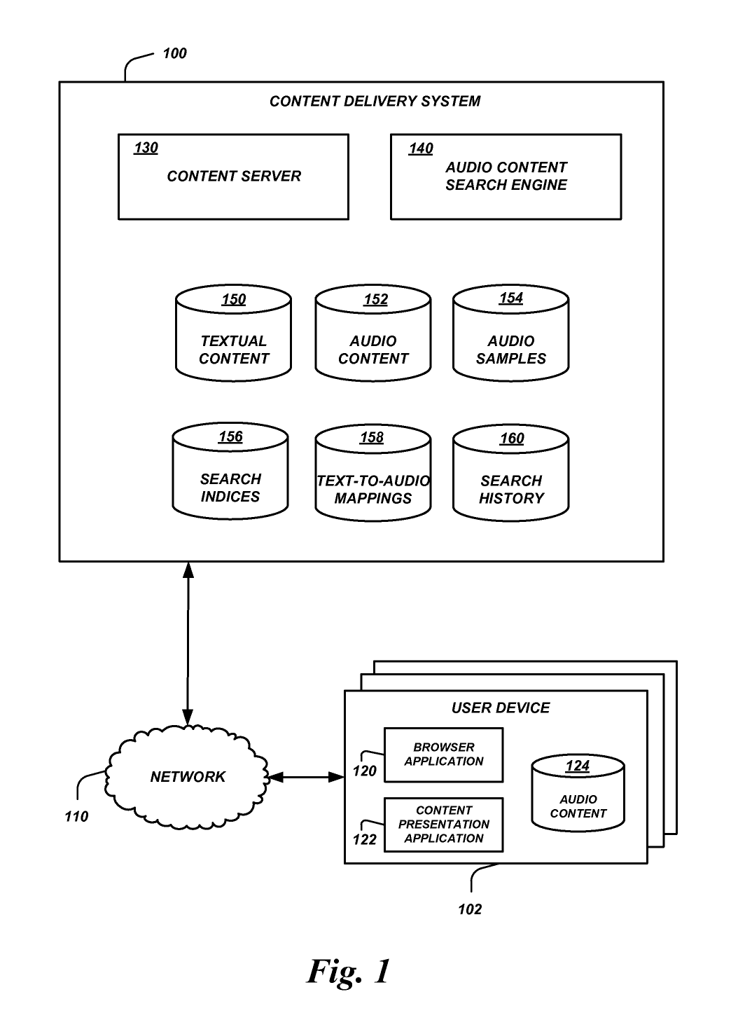

FIG. 1 illustrates a network environment including an example content delivery system 100 communicating with various user devices 102 over a communication network 110. The communication network 110 may be any wired network, wireless network, or combination thereof. In addition, the network 110 may be a personal area network, local area network, wide area network, cable network, satellite network, cellular telephone network, or combination thereof. For example, the communication network 110 may be a publicly accessible network of linked networks, possibly operated by various distinct parties, such as the Internet. In some embodiments, the communication network 110 may be a private or semi-private network, such as a corporate or university intranet. The communication network 110 may include one or more wireless networks, such as a Global System for Mobile Communications (GSM) network, a Code Division Multiple Access (CDMA) network, a Long Term Evolution (LTE) network, or some other type of wireless network. Protocols and components for communicating via the Internet or any of the other aforementioned types of communication networks are well known to those skilled in the art of computer communications and thus, need not be described in more detail herein.

The user devices 102 can correspond to a wide variety of electronic devices. In some embodiments, a user device 102 may be a computing device that includes one or more processor devices and a memory which may contain software applications executed by the processors devices. A user device 102 may include speakers and/or displays for presenting content. In addition, a user device 102 may be configured with one or more wired or wireless network antennae or wired ports to facilitate communication with content delivery system 100. The software of a user device 102 may include components, such as a browser application 120, for establishing communications over the communication network 110. In addition, the software applications may include one or more content presentation applications 122 that play or otherwise execute audio programs such as music or audio books, video programs such as movies or television shows, and video games. Illustratively, any of the user devices 102 may be a personal computing device, laptop computing device, hand held computing device, terminal computing device, mobile device (e.g., mobile phones or tablet computing devices), wearable device configured with network access and program execution capabilities (e.g., “smart eyewear” or “smart watches”), wireless device, electronic reader, media player, home entertainment system, gaming console, set-top box, television configured with network access and program execution capabilities (e.g., “smart TVs”), or some other electronic device or appliance.

The content delivery system 100 can be any computing system that is configured to communicate via a communication network. For example, the content delivery system 100 may include any number of server computing devices, desktop computing devices, mainframe computers, and the like. In some embodiments, the content delivery system 100 can include several devices physically or logically grouped together, such as a content server 130 configured to provide user interfaces and access to content items, an audio content search engine 140 configured to execute searches within audio content items, and various data stores of content items and information that may be used to facilitate searching with in audio content items. As shown in FIG. 1, the data stores may include a textual content data store 150, an audio content data store 152, an audio samples data store 154, a search indices data store 156, a text-to-audio mappings data store 158, a search history data store 160, some combination thereof, and/or other data stores. In some embodiments, the content delivery system 100 can include various modules and components combined on a single device, multiple instances of a single module or component, etc. For example, the content delivery system 100 may include a server or group of servers configured to provide the functionality of both the content server 130 and the audio content search engine 140, and a separate server or group of servers that manage the data stores.

In multi-device implementations, the various devices of the spoken language processing system 102 may communicate via an internal communication network, such as a corporate or university network configured as a local area network (“LAN”) or a wide area network (“WAN”). In some cases, the devices of the spoken language processing system 102 may communicate over an external network, such as the Internet, or a combination of internal and external networks.

In some embodiments, the features and services provided by the content delivery system 100 may be implemented as web services consumable via a communication network 110. In further embodiments, the content delivery system 100 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

### Process for Searching Within Audio Content

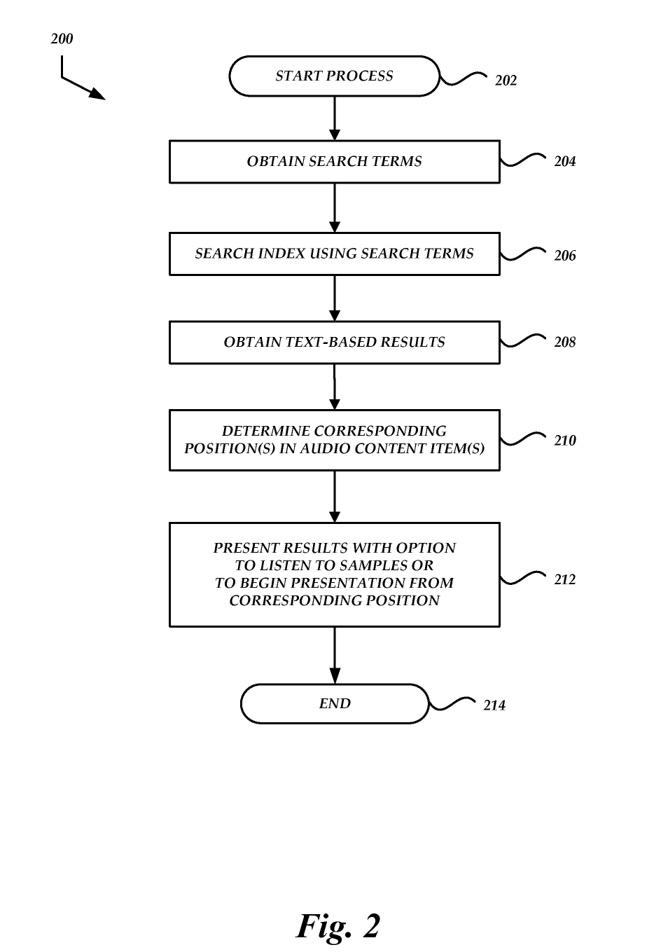

Turning now to FIG. 2, an illustrative process 200 for searching within audio content will be described. The process 200 may be performed to search within a single audio content item or across a catalog of audio content items. The process 200 can be implemented by a network-accessible search engine, such as an audio content search engine 140 of a content delivery system 100. In some embodiments, the process 200 may be implemented by a locally executing application of a user device 102, such as a content presentation application 122.

The process 200 begins at block 202. The process 200 may be embodied in a set of executable program instructions (also referred to in some instances as a module) stored on a non-transitory computer-readable medium, such as one or more disk drives, of a computing system. When the process 200 is initiated, the executable program instructions can be loaded into memory, such as RAM, and executed by one or more processor devices of the computing system.

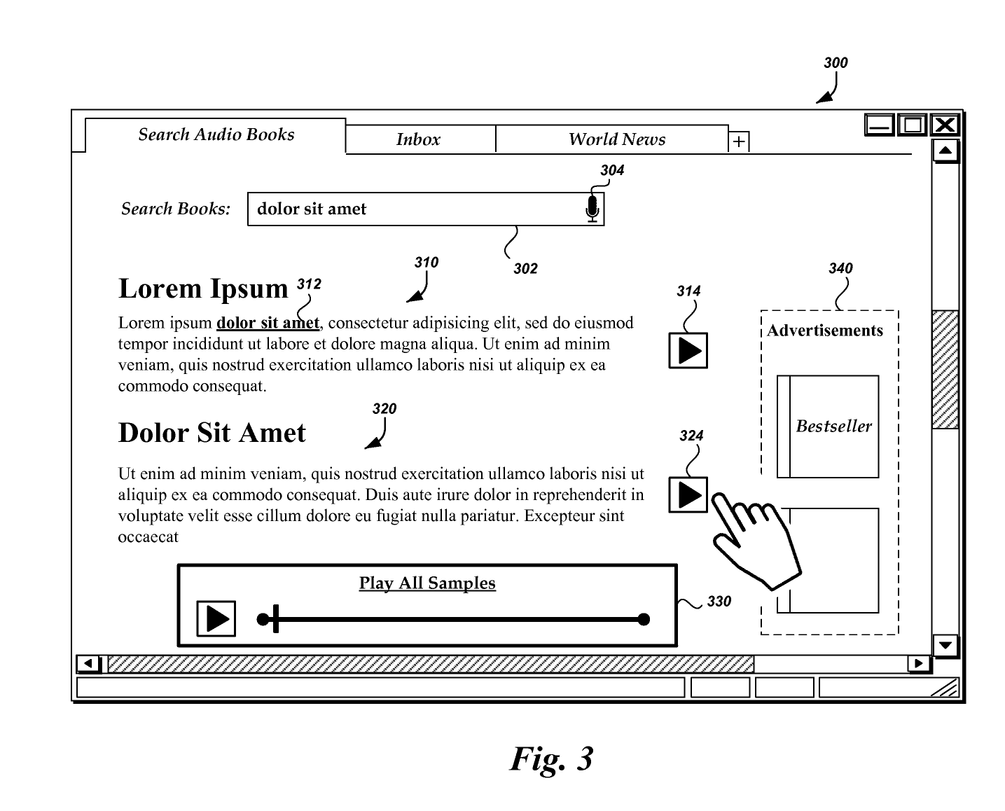

At block 204, the computing device executing the process 200 can obtain search terms. Search terms may include one or more words that a user wishes to locate in a specific audio content item or in a catalog of audio content items. Alternatively, a user may wish to obtain a listing of content items that include one or more words included in the search terms (e.g., the user is not interested in specific locations of the search terms within the content items, but rather the identities of content items that include the search terms). In some embodiments, the search terms may include additional parameters, such as specific authors, titles, or other information associated with content items. A user may provide search terms by, e.g., typing text into a text box presented by a browser application 120 or content presentation application 122. In some embodiments, search terms may be spoken by a user, and a speech recognition system may generate textual search terms. FIGS. 3, 4 and 5 show example user interfaces for submitting search terms and interacting with search results.

FIG. 3 shows an illustrative user interface 300 presented by a browser application 120 or some other application of a user device 102. A user may access the user interface 300 in order to search across a catalog of audio content items, a catalog including both audio content items and textual content items, a catalog of content in a variety of formats, a catalog of heterogeneous products, etc. In some embodiments, the interface 300 may be generated by the audio content search engine 140 as a markup language file (e.g., a HyperText Markup Language or HTML file) or some other network resource, and transmitted to the user device 102 via the communication network 110. As presented on the user device 102, the interface 300 includes a search box 302 for entry of search terms. A user may also provide search terms verbally, as indicated by the speech recognition icon 304. Search terms input into the search box 302 may be transmitted to the audio content search engine 140.

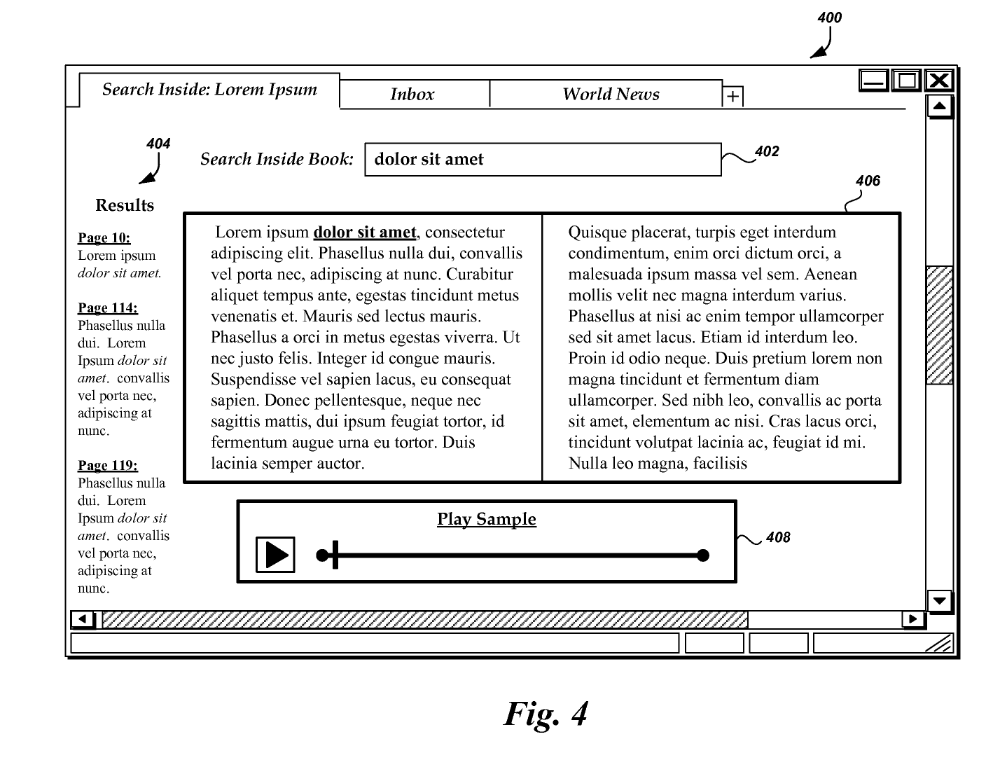

FIG. 4 shows another illustrative user interface 400 presented by a browser application 120 or some other application of a user device 102. A user may access the user interface 400 in order to, e.g., search inside an individual content item. For example, the user may be browsing a particular content item, and may wish to search for particular audio or textual passages in the content item. As another example, the user may view a preview of an e-book in text pane 406, and may be permitted to search the e-book's content. Audio that corresponds to the text presented in the text pane 406 may be provided to the user in order to give the user a richer browsing experience, or to entice the user to purchase an audio book instead of, or in addition to, an e-book. In some embodiments, the interface 400 may be generated by the audio content search engine 140 as a markup language file or some other network resource, and transmitted to the user device 102 via the communication network 110. As presented on the user device 102, the interface 400 includes a search box 402 for entry of search terms. Search terms input into the search box 302 may be transmitted to the audio content search engine 140.

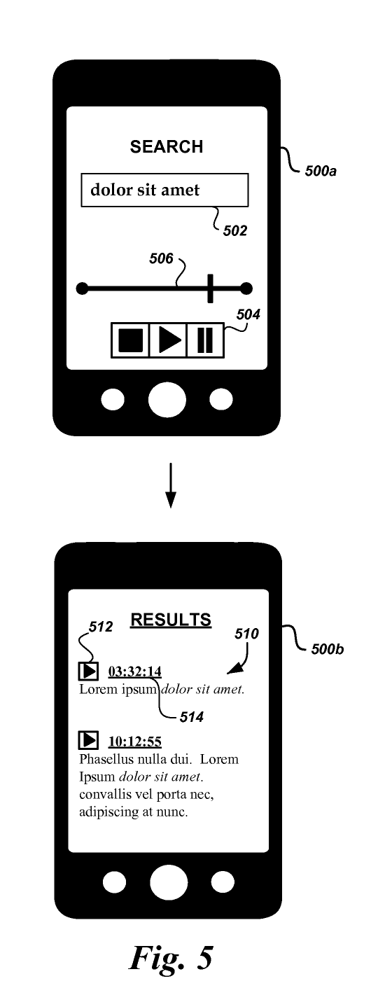

FIG. 5 shows an illustrative user interface 500a presented by a content presentation application 122 or some other application of a user device 102. A user may access the user interface 500a in order to, e.g., search inside an individual content item. For example, the user may be consuming an audio content item using the playback controls 504 and progress bar 506 presented on a display of the user device 102. The user may wish to search for a portion of the audio content item in which a particular word or phrase is spoken. A user may input search terms into search box 502 (e.g., by typing, speaking a voice command, etc.) As presented on the user device 102, the interface 500a includes a search box 502 for entry of search terms. Search terms input into the search box 502 may be processed locally by the content presentation application 122. In some embodiments, search terms input in the search box 502 may be transmitted to the audio content search engine, such as when a user is only authorized to have an audio version of the content item stored locally, and therefore a transcript or textual search index may not be stored locally.

The user interfaces shown in FIGS. 3, 4 and 5 are illustrative only, and are not intended to be limiting. In some embodiments, a user interface may have additional, fewer, or alternative elements. In some embodiments, elements of one of the user interfaces 300, 400, or 500a may be included in another user interface. For example, the user interface 500a shown in FIG. 5 may also include aspects of the interface 300 for searching across a catalog of content items. The catalog may be the user's personal catalog, or it may be a catalog of content items available for purchase or browsing at a content delivery system 100. In addition, the search terms and search results shown in FIGS. 3, 4 and 5 and described herein are only examples. Specific search terms and search results vary from user-to-user, system-to-system, or based on any number of parameters or implementations.

Returning to FIG. 2, at block 206 the computing device executing the process 200 may search one or more search indices using the search terms. A search index for the current book or for a catalog of books may include entries for various words or phrases. If searching in a single content item, the computing device may search for results that correspond to different locations in the content item (e.g., a page number, section number, or word number in an e-book, or a play position in an audio book) at which one or more of the search terms may be found. If searching in a catalog of multiple content items, the computing device may search for results that correspond to the location of the most relevant instance of one or more search terms in each of multiple content items.

At block 208, the computing device executing the process 200 may obtain results from searching the index. The results may be text-based results, such as passages of text (or data indicating the locations of the passages of text in an e-book) that include instances of the search terms. The passages may include contextual information (e.g., words occurring before and/or after the instance of the search term, such as one or more sentences). For example, the computing device can locate an instance of a search term in the search index, and obtain a textual passage of the search term in context and/or other information about the most relevant result or top n most relevant results (where n is some positive integer).

At block 210, the computing device executing the process 200 may determine play positions in one or more audio content items that correspond to the search results obtained above. The play positions may be included in the search index, such that the play positions are obtained directly from the index. In some embodiments, a cross reference of words or text locations to corresponding play positions, such as the text-to-audio mappings 158, may be queried using information obtained from the search index. A play position obtained using these methods may correspond to the play position at which a given search term is spoken in the audio content item. If a user were to begin playback of the audio content at such a position, playback may begin in the middle of a sentence or otherwise may not be user-friendly. Determination of the corresponding play position may therefore include adding some offset or buffer to the play position (e.g., a predetermined amount of audio before the play position of a search term, such as 5 seconds), identifying a play position that corresponds to the beginning of the contextual information, identifying a play position that corresponds to the beginning of a sentence/paragraph/page/chapter, or otherwise determining a position that provides a satisfactory user experience.

In some embodiments, an ending play position may also be obtained or determined. The ending play position can be used to ensure that a user may not begin listening to a search result in context and proceed to listen to the remainder of the content item in its entirety. The ending play position may be some predetermined offset, period of time, number of words, or other measurement with respect to a beginning play position for the search result.

At block 212, the computing device executing the process 200 may cause presentation of search results. The presentation may include an option to listen to samples associated with the search results or to begin presentation of the audio content item from a position that corresponds to a search result. FIGS. 3, 4 and 5 show example user interfaces for presenting and interacting with search results.

FIG. 3 shows multiple search results 310, 320 returned from a search for the terms submitted in the search box 302. An audio content search engine 140 may provide the search results in a markup language file or some other network resource transmitted to the user device, as described above. Search result 310 includes presentation of a textual passage of the corresponding content item with the search terms 312 in context. Search result 320 includes presentation of a search result obtained by finding the search terms in the title of the content item. A general textual passage may be presented in such case, such as a default or introductory passage assigned to the content item. In some embodiments, a relevant instance of the search terms in context may be presented, if available.

In addition to the textual passages, audio samples 314, 324 may be provided with the search results 310, 320, respectively. For example, a user may activate audio sample 324, and presentation of a portion of the audio content item corresponding to the displayed textual passage may begin. Presentation may begin from the play position determined above at block 210 of the process 200. The audio sample may be streamed to a user device 102 via the communication network 110 during playback, transmitted as a separate file along with the search results or in response to activation of the audio sample, etc.

In some embodiments, an audio sample may not directly correspond to a textual passage presented to the user in the search results. For example, the audio sample may continue to play for some period of time after the words in the textual passage have been spoken. As another example, the audio sample may include some number of words or sentences before the words in the textual passage. As yet another example, the audio sample may include additional information, such as the title, author, or other information associated with the audio content item. Audio presentation of such information may be generated by a text-to-speech component or service, or some other speech synthesis component or service. Illustratively, a text-to-speech component executing at or in connection with the audio content search engine 140 may be used to generate an audio presentation of such information for inclusion in the audio sample. The audio presentation of such information may be generated in response to the particular search initiated by the user. Alternatively, a predetermined set of samples may be generated that may include audio presentation of additional information. One or more of the predetermined set of samples may be provided to the user in response to a search request.

In some embodiments, an option to present multiple audio samples consecutively may be provided. For example, in addition to individual audio samples 314 and 324, a combined audio sample 330 may be presented. The combined audio sample 300 may include any number of audio samples, such as audio sample for each individual search result returned to the user, an audio sample for the search results currently displayed in the interface 300, an audio sample for the top n search results (where n is some positive integer), or some other combination of audio samples. In some embodiments, additional information may be included at the beginning or ending of the combined audio sample, or between individual audio samples presented in the combined audio sample. The additional information may include titles, authors, or other information about individual samples or the collection of samples as a whole. For example, a summary of the search results may be included, such as a read-back of the search terms, an indication of the number of search results obtained, and the like. Such information may be generated by a text-to-speech component or service, or some other speech synthesis component or service, as described above with respect to the individual audio samples 314, 324.

FIG. 4 shows a search results list 404 generated in connection with a search for the terms submitted in the search box 402. As described above, a user may access the interface 400 to search the content of a particular content item, such as an e-book. In addition to presentation of search results 404 with search terms in context, the user may initiate presentation of a larger sample that includes the search terms. For example, a user may access one or more full or partial pages of an e-book in response to selecting a particular result in the search results list 404 (in FIG. 4, the first result in the list 404 is presented). The sample may be presented in a text pane 406, embedded e-book viewer, or some other user interface component. An audio sample 408 may also be provided to the user. The audio sample 408 may correspond to the text currently displayed in the text pane 406. If a user selects a different result from the search results 404, both the text pane 406 and the audio sample 408 can be updated to provide samples of the selected result. The user may initiate presentation of the audio sample 408, and a portion of the audio content can begin playback from a play position determined above at block 210 of the process 200.

In some embodiments, the text in the text pane 406 that corresponds to words currently being presented in the audio sample 408 may be visually indicated. For example, one or more words may be underlined, highlighted, bolded, or otherwise altered. The particular words that are visually indicated in the text pane 406 can be updated dynamically as playback of the audio sample 408 continues, such that they remain substantially synchronized with playback of the audio sample 408.

FIG. 5 shows a user interface 500b displaying a search results list 510 generated in connection with a search for the terms submitted in the search box 502 of interface 500a. As described above, a user may access the interface 500a to search the content of a particular content item, such as an audio book that is stored on or currently being presented on a user device. The search terms may have been submitted by a content presentation application 122 to a network-accessible search engine, such as the audio content search engine 140 of the content delivery system 100. In response, the search engine may provide search results, such as text passages and/or corresponding play positions, to the content presentation application 122. The content presentation application 122 may subsequently display the search results to the user, including text passages with the search terms in context, play position indicators, and/or other relevant information. In addition, a control 512 or other user option may be displayed so that a user may initiate playback of the content item from one of the play positions.

In some embodiments, searching of the content item may be partially or completely performed locally, at a user device 102. A content presentation application 122 or some other application or component may access a transcript or search index associated with the audio book. The application may perform some or all of the search functions described above with respect to the audio content search engine 140. In some embodiments, the search index or transcript may be encrypted or otherwise processed to reduce the risk of unauthorized access and reverse engineering. For example, words and/or other information in a search index may be hashed. Hashing a word can produce an encrypted token that cannot be unencrypted. However, if the same word is submitted as a search term and hashed using the same hash function and key as the words in the index, the resulting token will be identical to the previously hashed token. Accordingly, search terms may be hashed and the encrypted tokens can be used to search an index of hashed words, obtain play positions, etc. Other aspects of searching such an index may substantially the same as those described above.

### Process for Using Search History to Select Samples of Audio Content

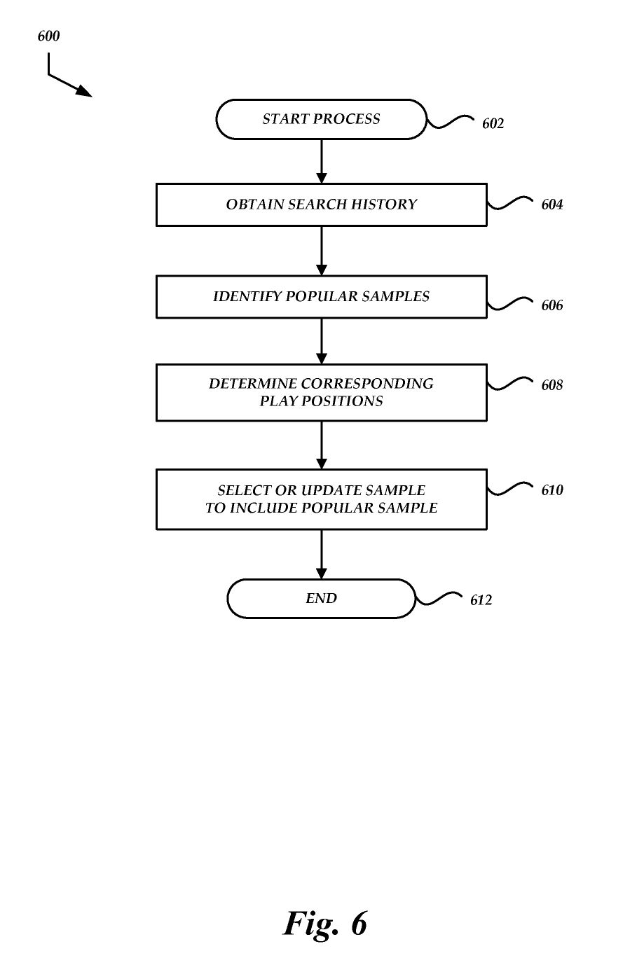

Turning now to FIG. 6, an illustrative process 600 for selecting popular or otherwise desirable samples of audio content will be described. The process 600 may be performed by some module or component of a content delivery system 100 with access to information about historical searches and user interactions with those searches. A default audio sample for a given audio content item may be selected based on which audio samples are popular among users. As another example, search results for certain search terms (either within a content item or across a catalog of content items) may be re-ranked based on which audio samples associated with the search results for the search terms are popular.

The process 600 begins at block 602. The process 600 may be executed on-demand (e.g., upon initiation by system administrators or other personnel), or it may be an automated process that updates audio samples on a regular or irregular basis or in response to some event. The process 600 may be embodied in a set of executable program instructions stored on a non-transitory computer-readable medium, such as one or more disk drives, of a computing system. When the process 600 is initiated, the executable program instructions can be loaded into memory, such as RAM, and executed by one or more processors of the computing system.

At block 604, the computing device executing the process 600 can obtain data regarding search history and interactions with historical search results. Search history may be stored in, and accessed from, a search history data store 160. Data may be stored reflecting which search terms have been submitted, and which audio samples associated with search results for those search terms have been accessed. For example, each time a user accesses an audio sample provided in connection with a search, a record may be stored regarding the sample (e.g., the submitted search term and the play position of the audio sample access), a counter associated with the sample may be incremented, etc. In some embodiments, other data may be stored, such as demographic data regarding users accessing the audio samples, data regarding user device types and characteristics, contextual data such as a timestamp, etc.

At block 606, the computing device executing the process 600 can identify the most popular search results for a given search term, a given audio content item, or combination thereof. The popular search result may be determined based upon the entirety of the available search history, or it may be based on some selective criteria, such as a particular period of time (e.g., the previous week, month, or year), demographic characteristics of users, etc. For example, different audio samples may be identified for different users. Users may be grouped by or associated with particular demographic characteristics, and audio samples that are most popular (or predicted to be most popular) among users sharing that demographic characteristic may be identified.

At block 608, the computing device executing the process 600 can determine play positions corresponding to the sample(s) identified above. The play positions may be included in the search history 160, or the computing device may perform a process to determine the appropriate play positions. For example, the computing device may query the text-to-audio mappings 158 if information about the specific instance of the search term associated with the popular audio sample is available.

At block 610, the audio sample for the particular search term or content item may be updated. Data indicating content items, search terms, and corresponding play positions may be stored in an audio samples data store 154. Subsequently, when a search term is submitted, the audio content search engine 140 may generate the search results based at least partly on the data in the audio samples data store 154. In some embodiments, the audio content search engine 140 may rank the instance of the search term associated with the most popular audio sample as the top search result (or otherwise elevate the instance of the search term based on the popularity of the corresponding audio sample). In some embodiments, as described above, a default sample for a particular content item may be based on a popular audio sample identified in the audio samples data store 154. Subsequently, when a user browses audio content items and access a sample for the particular content item, the most popular audio sample may be presented to the user.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor such that the processor can read information from, and write information to, the storage medium. In the alternative, the storage medium can be integral to the processor device. The processor device and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a data store configured to store computer-executable instructions; and
a computing device in communication with the data store, the computing device, when executing the computer-executable instructions, configured to at least:
receive a request to search an audio book, the request comprising a textual representation of a search term;
identify, based at least partly on an index of words in the audio book, a starting play position in the audio book, wherein the starting play position corresponds to an audio representation of an instance of the search term;
determine an ending play position in the audio book based at least partly on the starting play position; and
provide access to a portion of the audio book, the portion based at least partly on the starting play position and the ending play position.

2. The system of claim 1, wherein the computing device is further configured to at least determine the starting play position based at least partly on an offset from the audio representation of the instance of the search term.

3. The system of claim 1, wherein the computing device is further configured to at least:
identify a plurality of play positions in the audio book, wherein each of the plurality of play positions corresponds to an audio representation of a different instance of the search term; and
provide access to a plurality of portions of the audio book, each of the plurality of portions based at least partly on a different play position of the plurality of play positions.

4. The system of claim 1, wherein the computing device is further configured to at least store historical search data reflecting a request to access the portion of the audio book in connection with a prior request to search the audio book, wherein the prior request comprises a textual representation of the search term.

5. The system of claim 4, wherein the computing device is configured to at least identify the play position of the audio book further based at least partly on the historical search data.

6. A computer-implemented method comprising:
under control of one or more computing devices configured with specific computer-executable instructions,
receiving a request to search audio content, the request comprising a textual representation of a search term;
identifying, based at least partly on a search index of text presented audibly in the audio content, one or more instances of the search term;
determining a play position associated with the audio content based at least partly on an instance of the one or more instances of the search term; and
providing access to a portion of the audio content, the portion based at least partly on the play position.

7. The computer-implemented method of claim 6, wherein the one or more computing devices comprise at least one of a user device, or a network-accessible audio content search engine.

8. The computer-implemented method of claim 6, wherein the audio content comprises at least one of a plurality of audio content items, or an individual audio content item.

9. The computer-implemented method of claim 6, wherein the play position corresponds to at least one of a timestamp, an elapsed period of time, or a percentage of audio content.

10. The computer-implemented method of claim 6, wherein the play position is determined based at least partly on a popularity of a portion of the audio content corresponding to the play position.

11. The computer-implemented method of claim 6, further comprising storing historical search data reflecting a request to access the portion of the audio content in connection with a prior request to search the audio content, wherein the prior request comprises a textual representation of the search term.

12. The computer-implemented method of claim 11, wherein identifying the play position is further based at least partly on the historical search data.

13. The computer-implemented method of claim 6, further comprising determining an ending play position associated with the audio content based at least partly on the play position, wherein the portion of the audio content is further based at least partly on the ending play position.

14. The computer-implemented method of claim 6, further comprising:
identifying a plurality of play positions, each of the plurality of positions corresponding to a different audio representation of an instance of the search term; and
providing access to a plurality of portions of the audio content, each of the plurality of portions based at least partly on a different play position of the plurality of play positions.

15. A non-transitory computer storage medium storing computer executable instructions that, when executed by one or more computer systems, configure the one or more computer systems to perform operations comprising:
receiving a request to search audio content, the request comprising a textual representation of a search term;
identifying, based at least partly on a search index of text presented audibly in the audio content, one or more instances of the search term;
determining a starting play position associated with the audio content based at least partly on an instance of the one or more instances of the search term;
determining an ending play position associated with the audio content based at least partly on the starting play position; and
providing access to a portion of the audio content, the portion based at least partly on the starting play position and the ending play position.

16. The non-transitory computer storage medium of claim 15, wherein the audio content comprises at least one or a plurality of audio content items, or an individual audio content item.

17. The non-transitory computer storage medium of claim 15, wherein the operations further comprise determining the starting play position based at least partly on an offset.

18. The non-transitory computer storage medium of claim 15, wherein the operations further comprise determining the starting play position based on at least partly on at least one of: a beginning of a sentence, a beginning of a paragraph, a beginning of a page, or a beginning of a chapter.

19. The non-transitory computer storage medium of claim 15, wherein the operations further comprise providing a textual passage comprising the search term.

20. The non-transitory computer storage medium of claim 15, wherein the operations further comprise storing historical search data reflective of user access of the portion.

21. The non-transitory computer storage medium of claim 20, wherein the operations further comprise selecting a default audio sample based at least partly on the historical search data.
